(19) United States
(12) Patent Application Publication
(10) Pub. No.: US 2022/0229598 A1
(43) Pub. Date: Jul. 21, 2022

(54) STORAGE SYSTEM WITH STORAGE CLUSTER FOR PROVIDING VIRTUAL STORAGE SYSTEM

(71) Applicant: Hitachi, Ltd., Tokyo (JP)

(72) Inventors: Shinri INOUE, Tokyo (JP); Akihisa NAGAMI, Tokyo (JP); Koji WATANABE, Tokyo (JP); Hiroshi ARAKAWA, Tokyo (JP)

(73) Assignee: Hitachi, Ltd., Tokyo (JP)

(21) Appl. No.: 17/469,043

(22) Filed: Sep. 8, 2021

(30) Foreign Application Priority Data
Jan. 18, 2021 (JP) 2021-005516

(51) Int. Cl. G06F 3/06

(52) U.S. Cl. CPC G06F 3/0659; G06F 3/0647; G06F 3/067; G06F 3/0604; G06F 3/0632

(57) ABSTRACT

Service quality of a storage service provided by a storage cluster which can have a hetero configuration can be maintained. When a new node (a post-replacement or newly-added storage node) is added to the storage cluster, a storage system compares a spec of the new node with a spec of at least one existing node other than the new node. When the spec of the new node is higher than the spec of the existing node and a first volume (a volume associated with a priority higher than a first priority) exists in any one of the existing nodes, the storage system decides the new node as a migration destination of the first volume.

### CROSS-REFERENCE TO PRIOR APPLICATION

This application relates to and claims the benefit of priority from Japanese Patent Application number 2021-5516, filed on Jan. 18, 2021 the entire disclosure of which is incorporated herein by reference.

### BACKGROUND

The present invention generally relates to a technology for controlling volume deployment in a storage cluster which provides a virtual storage system.

It is desirable that service quality of a storage service provided to a user from a storage cluster which provides a virtual storage system (a cluster configured of two or more storage nodes) should be maintained to be the service quality desired by the user. A QoS (Quality of Service) function is known as a function to maintain the service quality.

A technology to which the QoS function is applied is disclosed in, for example, PTL 1. According to PTL 1, priorities are assigned to user VMs (Virtual Machines) and a network scheduling module performs control according to the priorities of the user VMs.

PTL 1: U.S. Pat. No. 9,424,059

### SUMMARY

It is considered preferable that specs of all the storage nodes in the storage cluster be the same in terms of management or maintenance in order to maintain the service quality of the storage service. However, it is not always easy to make a storage node, which becomes a new member of the storage cluster through replacement or addition of the storage node, have the same spec as that of the other storage nodes in the storage cluster. One of the reasons is that the manufacture and sale of the same storage nodes as the other storage nodes (or storage nodes having the same spec as that of the other storage nodes) might have been stopped at the time point of the replacement or addition of the storage node.

Therefore, the storage cluster may sometimes become a cluster configured of a plurality of storage nodes with different specs, that is, a storage cluster with a so-called hetero configuration. If the storage cluster has the hetero configuration, it becomes difficult to maintain the service quality. For example, at least one of the following may be possible.
Even if a volume with a high priority (level) of the service quality is deployed in a node with a high spec, this storage node becomes inappropriate as a deployment destination of a volume with a high priority if the spec of this storage node deteriorates over time or relatively degrades.
If a plurality of volumes with different priorities for the service quality are mixed in a storage node, that storage node may be accessed intensively and the expected service quality of the storage service may degrade.

A storage system includes a plurality of storage nodes including two or more storage nodes constituting a storage cluster for providing a virtual storage system. One or a plurality of volumes are deployed in the two or more storage nodes. A priority according to a service quality of a storage service using the volume(s) is associated with each of the one or the plurality of volumes. As the service quality of the storage service is higher, the priority associated with the volume used for the storage service tends to be high. When a new node which is a post-replacement or addition target storage node is added by replacing any one of the storage nodes in the storage cluster or adding a storage node to the storage cluster, a processing node (any one of the plurality of storage nodes) performs the following:
acquires new spec information which is information indicating a spec of the new node, and existing spec information which is information indicating a spec of at least one existing node other than the new node in the storage cluster;
compares a new spec, which is a spec indicated by the new spec information, with an existing spec which is a spec indicated by the existing spec information; and
decides the new node as a migration destination of a first volume (a volume associated with the priority equal to or higher than a first priority) if the new spec is higher than the existing spec and the first volume exists in any one of the existing nodes.

The service quality of the storage service provided by the storage cluster which can have the hetero configuration can be maintained according to the present invention.

### BRIEF DESCRIPTION OF DRAWINGS

FIG. 1 illustrates one example of an overall configuration of a system according to an embodiment of the present invention;

FIG. 2 illustrates one example of volume deployment;

FIG. 3 illustrates one example of information and programs stored in a memory for a storage node;

FIG. 4 illustrates a structure example of a node management table;

FIG. 5 illustrates a structure example of a volume management table;

FIG. 6 illustrates a structure example of a cluster management table;

FIG. 7 illustrates a structure example of an ALUA management table;

FIG. 8A illustrates part of the outline of one example of new node addition processing;

FIG. 8B illustrates the remaining outline of one example of the new node addition processing;

FIG. 9 illustrates a flow of processing executed when adding a new node;

FIG. 10 illustrates a flow of cluster management table update processing (S2 in FIG. 9);

FIG. 11 illustrates a flow of CPU performance comparison processing (S3 in FIG. 9);

FIG. 12 illustrates a flow of drive type judgment processing (S5 in FIG. 9);

FIG. 13 illustrates a flow of DIMM performance comparison processing (S7 in FIG. 9);

FIG. 14 illustrates a flow of NIC performance comparison processing (S9 in FIG. 9); and

FIG. 15 illustrates a flow of rebalance implementation possibility judgment processing (S14 in FIG. 9).

### DESCRIPTION OF EMBODIMENTS

In the following explanation, an “interface apparatus” may be one or more interface devices. The one or more interface devices may be at least one of the following:
One or more I/O (Input/Output) interface devices. The I/O (Input/Output) interface device is an interface device for at least one of an I/O device and a remote display computer. The I/O interface device for the display computer may be a communication interface device. At least one I/O device may be a user interface device, for example, either one of input devices such as a keyboard and a pointing device, and output devices such as a display device.
One or more communication interface devices. The one or more communication interface devices may be one or more communication interface devices of the same type (for example, one or more NICs [Network Interface Cards]) or two or more communication interface devices of different types (for example, an NIC and an HBA [Host Bus Adapter]).

Furthermore, in the following explanation, a “memory” is one or more memory devices, which are an example of one or more storage devices, and may typically be a main storage device. At least one memory device in the memory may be a volatile memory device or a nonvolatile memory device.

Furthermore, in the following explanation, a “persistent storage apparatus” may be one or more persistent storage devices which are an example of one or more storage devices. The persistent storage device may typically be a nonvolatile storage device (such as an auxiliary storage device) and may specifically be, for example, an HDD (Hard Disk Drive), SSD (Solid State Drive), NVME (Non-Volatile Memory Express) drive, or SCM (Storage Class Memory).

Furthermore, in the following explanation, a “storage apparatus” may be a memory and at least a memory for the persistent storage apparatus.

Furthermore, in the following description, a “processor” may be one or more processor devices. The at least one processor device may typically be a microprocessor device like a CPU (Central Processing Unit), but may be a processor device of a different type like a GPU (Graphics Processing Unit). The at least one processor device may be of a single-core type or a multi-core type. The at least one processor device may be a processor core. The at least one processor device may be a processor device in a broad sense such as a circuit which is an aggregate of gate arrays by hardware descriptive language for executing a part or whole of processing (such as an FPGA (Field-Programmable Gate Array), CPLD (Complex Programmable Logic Device), or an ASIC (Application Specific Integrated Circuit)).

Furthermore, in the following description, information which is obtained as output in response to input may be sometimes described by an expression like “xxx table”; however, such information may be data of any type of whatever structure (for example, either structured data or unstructured data) or may be a learning model which outputs in response to input and are represented by a neural network, a genetic algorithm, and a random forest. Therefore, the “xxx table” can be expressed as “xxx information.” Furthermore, in the following description, the structure of each table is one example and one table may be divided into two or more tables or all or some of two or more tables may be one table.

Furthermore, in the following description, processing may be sometimes described by referring to a “program” as a subject; however, the program is executed by a processor and thereby performs defined processing by using a storage apparatus and/or an interface apparatus as appropriate, so that the subject of the processing may be the processor (or an apparatus or system having that processor). The program may be installed from a program source into a device like a computer. The program source may be, for example, a program distribution server or a computer-readable storage medium (such as a non-transitory storage medium). Furthermore, in the following description, two or more programs may be implemented as one program or one program may be implemented as two or more programs.

Furthermore, the identification number of an element is an example of identification information (ID) of the element and the identification information of the element(s) is not limited to the identification number as long as it is information for identifying the relevant element; and any information which uses other kinds of reference numerals may be used.

Embodiments of the present invention will be explained with reference to the drawings.

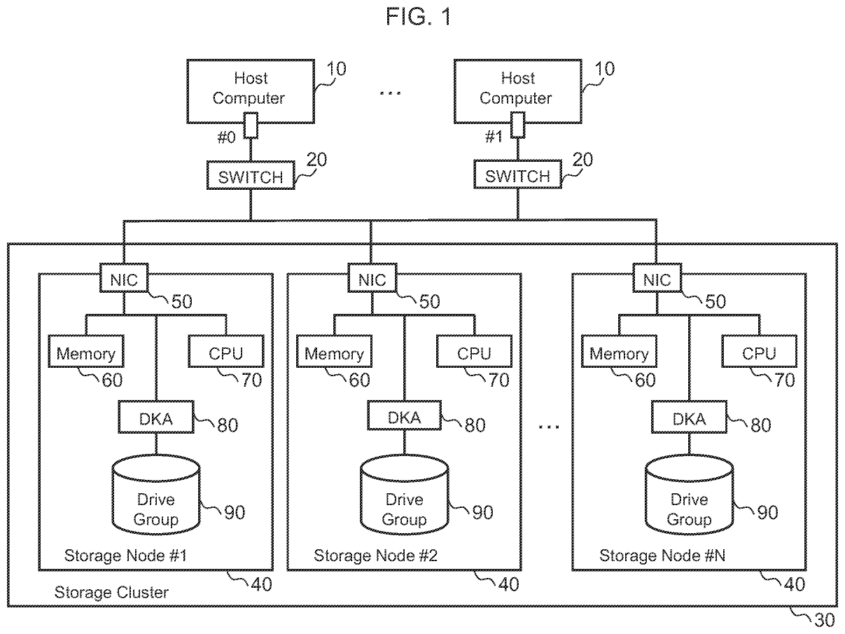

FIG. 1 illustrates a configuration example of the entire system according to an embodiment of the present invention.

A storage cluster 30 is coupled to a plurality of host computers 10 (or one host computer 10) via a network (for example, one or more switches 20). The host computer 10 is a computer which transmits an I/O (input/output) request to the storage cluster 30 and transmits/receives I/O target data.

The storage cluster 30 includes a plurality of storage nodes 40 which provide one virtual storage system. A storage node (hereinafter simply referred to as a “node”) 40 may be a general-purpose computer. The plurality of nodes 40 may provide SDx (Software-Defined anything) as one virtual storage system by execution of specified software by each node. For example, SDS (Software-Defined Storage) or SDDC (Software-defined Datacenter) may be adopted as SDx. There may be no host computer 10 and at least one node may have both a storage function inputting/outputting I/O target data to/from a logical volume(s) in response to an I/O request and a host function issuing an I/O request to the storage function.

The node 40 includes an NIC (Network Interface Card) 50, a memory 60, a DKA (display adapter) 80, a CPU 70 which is coupled to the above-listed elements, and a drive group 90 coupled to the DKA 80. The NIC 50 and the DKA 80 are an example of an interface apparatus. The drive group 90 is an example of a persistent storage apparatus. An CPU 70 is an example of a processor.

The NIC 50 is an interface device which communicates with the host computer 10 via the switch 20, and is an example of a frontend interface device. The DKA 80 is an interface device which controls input/output of data to/from the drive group 90, and is an example of a backend interface device.

The drive group 90 is one or more drives. The drive(s) is an example of a persistent storage device(s) and may be, for example, an HDD or an SSD.

The memory 60 stores programs and data. The CPU 70 provides the storage service to input/output data to/from the volume(s) by executing programs stored in the memory 60.

The system according to this embodiment may be applied to an environment where a revenue sharing type agreement is adopted. In other words, in this embodiment, a storage vendor who provides the storage cluster 30, a service provider who provides the storage service based on the storage cluster 30, and an end user who uses the storage service may exist. The service provider may receive a usage amount of money for the storage service from the end user and pay a service consideration to the storage vendor. The service consideration may include a consideration for a service to maintain the service quality which would satisfy the end user.

The service quality of the storage service depends on I/O performance and the I/O performance depends on volume deployment.

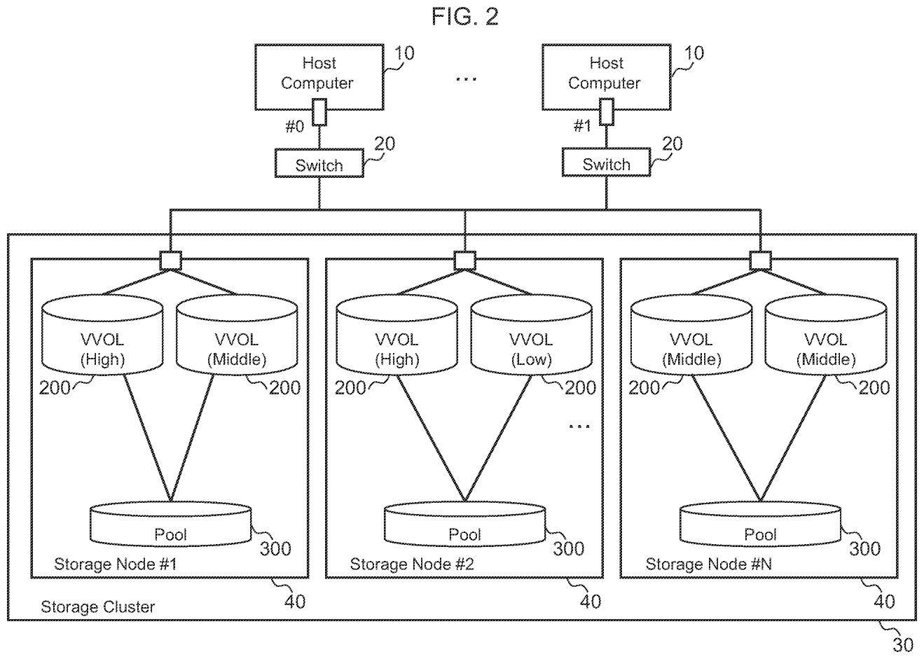

FIG. 2 illustrates an example of the volume deployment.

Volumes are logical storage areas provided to the host side. A volume(s) may be a real volume(s) (RVOL) or may be a virtual volume(s) (VVOL). An “RVOL” may be a VOL based on the drive group 90 and a “VVOL” may be a volume according to the capacity virtualization technology (typically, Thin Provisioning). In this embodiment, a volume(s) in each node 40 is a VVOL(s) 200 and the VVOL 200 is associated with a pool 300. The pool 300 is configured of one or more pool volumes. The pool volume(s) may be an RVOL(s). If the node 40 receives a write request and a real area (an area in the pool 300) is not associated with a virtual area designated by the write request (an area in the VVOL 200), the node 40 allocates a free real area (for example, a free real page) from the pool 300, which is associated with the VVOL 200 having the relevant virtual area (for example, a virtual page), to that virtual area and writes write target data to the relevant real area.

Regarding priorities of the service quality (for example, an SLA [Service Level Agreement]), for example, there are three levels: “High,” “Middle,” and “Low.” Any one of the priorities is associated with the VVOL 200.

Incidentally, redundancy of data stored in VVOLs 200 may be implemented by an arbitrary method. For example, the data redundancy may be implemented by any of the following.
The drive group 90 is one or more RAID (Redundant Array of Independent (or Inexpensive) Disks) groups. Real areas (pool volumes) are storage areas based on the RAID group(s). Therefore, data stored in a real area is made redundant according to a RAID level of a RAID group which is the basis of the relevant real area.
There are a plurality of redundant groups as described later. A redundant group is composed of an active node and one or more standby nodes. The active node receives a write request to a VVOL 200, allocates real areas in a standby node(s) in the same redundant group, other than real areas in the active node, to a virtual area which is a write destination, and stores the data in these real areas.

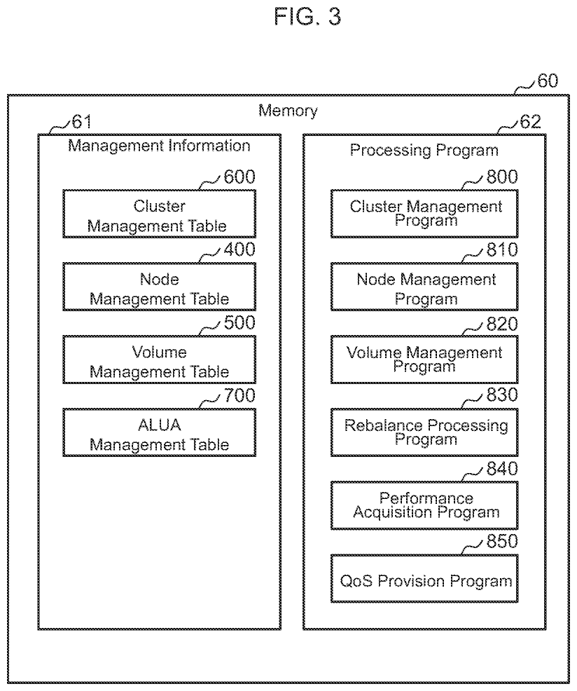

FIG. 3 illustrates an example of information and programs stored in the memory 60 for the node 40.

The memory 60 stores management information 61 and a processing program 62.

The management information 61 includes a node management table 400, a volume management table 500, a cluster management table 600, and an ALUA management table 700 (ALUA is an abbreviation of Asymmetric Logical Unit Access). The node management table 400 is a table for managing nodes 40. The volume management table 500 is a table for managing volumes. The cluster management table 600 is a table for managing the storage cluster 30. The ALUA management table 700 is a table for managing targets with shortest paths coupling the nodes 40 and the host computers 10 with respect to each volume.

The processing program 62 includes a cluster management program 800, a node management program 810, a volume management program 820, a rebalance processing program 830, a performance acquisition program 840, and a QoS provision program 850. The cluster management program 800 is a program for managing the storage cluster 30. The node management program 810 is a program for managing the nodes 40. The volume management program 820 is a program for managing the volumes. The rebalance processing program 830 is a program for redeploying the volumes. The performance acquisition program 840 is a program for obtaining various types of performance. The QoS provision program 850 is a program for performing QoS control to maintain the service quality according to the priority of the relevant volume(s).

In this embodiment, each node 40 has the processing program 62, so that each node 40 has a function redeploying the volume(s). Instead of or in addition to this, a management system for the storage cluster 30 (for example, one or more physical computers coupled to at least one node 40 in the storage cluster 30 in a communicable manner or a system implemented on the one or more physical computers) may store at least part of the management information 61 and execute at least part of the processing program 62. In other words, the management system may redeploy the volume(s).

Some tables will be explained below. Incidentally, in the following explanation, an element AAA with its identification number “n” may be sometimes expressed as “AAA #n.” For example, the node 40 with the identification number “1” may be sometimes expressed as the “node #1.”

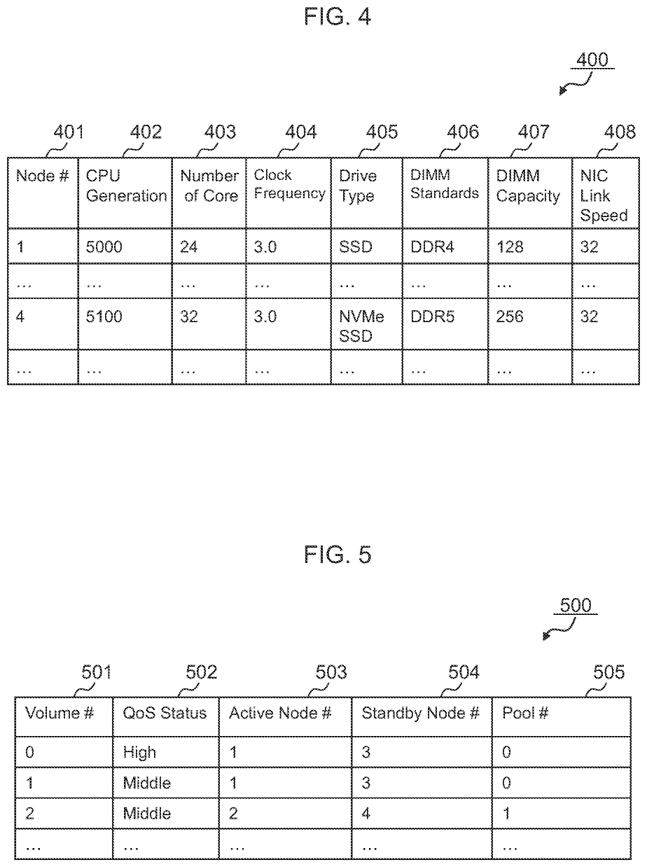

FIG. 4 illustrates a structure example of the node management table 400.

The node management table 400 has an entry for each node. Each entry retains information of a node number 401, a CPU generation 402, the number of cores 403, a clock frequency 404, a drive type 405, DIMM standards 406, a DIMM capacity 407, and an NIC link speed 408. In this embodiment, a spec of the node 40 depends on at least one of the CPU generation, the number of cores, the clock frequency, the drive type, the DIMM standards, the DIMM capacity, and the NIC link speed. One node 40 will be taken as an example (a “target node 40” in the explanation of FIG. 4).

The node number 401 indicates the identification number of the target node 40. The CPU generation 402 indicates the generation of the CPU 70 possessed by the target node 40. The number of cores 403 indicates the number of cores of the CPU 70 possessed by the target node 40. The clock frequency 404 indicates a clock frequency of the CPU 70 possessed by the target node 40. The drive type 405 indicates a type of a drive(s) in the drive group 90 possessed by the target node 40. The DIMM standards 406 indicate standards for a DIMM (Dual Inline Memory Module) in the memory 60 possessed by the target node 40. The DEV IM capacity 407 indicates a capacity of the DEV IM for the memory 60 possessed by the target node 40. The NIC link speed 408 indicates a link speed of the NIC 50 possessed by the target node 40.

FIG. 5 illustrates a structure example of the volume management table 500.

The volume management table 500 has an entry for each volume (VVOL 200). Each entry retains information of a volume number 501, a QoS status 502, an active node number 503, a standby node number 504, and a pool number 505. One volume will be taken as an example (a “target volume” in the explanation of FIG. 5).

The volume number 501 indicates the identification number of the target volume. The QoS status 502 indicates the priority of the target volume. In this embodiment, there are three levels “High,” “Middle,” and “Low” as the priorities (levels of the service quality) of the relevant volume; however, the priority levels may be more than or less than the three levels. The priority “High” requires the highest service quality (for example, the most excellent response performance). The priority “Middle” requires the second highest service quality.

If a failure occurs in any one of the nodes 40 in the storage cluster 30 and that node 40 is the active node 40, a failover is performed from that node 40 to any one of the one or more standby nodes 40 (for example, a node 40 with the highest priority as a failover destination) for the relevant node 40. A combination of the active node 40 and the one or more standby nodes 40 may be called a “redundant group.” The redundant group may be prepared in arbitrary units. For example, each node 40 may have a plurality of control programs (for example, at least one specified program of the processing program 62) and a control program group which is a group of two or more control programs which are respectively possessed by two or more different nodes 4 may correspond to a redundant group. An accessible storage area(s) may be determined for each control program group. The “accessible storage area(s)” herein used may be a volume(s) or one or more virtual areas among a plurality of virtual areas constituting a volume. In this embodiment, a redundant group is determined for each volume (VVOL 200).

Specifically speaking, the active node number 503 indicates the identification number of the active node 40 where the target volume is deployed. The standby node number 504 indicates the identification number of the standby node 40 which is a migration destination of the target volume upon the failover.

The pool number 505 indicates the identification number of a pool 300 associated with the target volume. The active node number 503 and the standby node number 504 share a common pool number 505; and this is because when the target volume is migrated to the standby node 40 upon the failover, it will be associated with the pool 300 with the same pool number as that of the pool 300 with which the target volume in the active node 40 is associated. Incidentally, the pool number of the pool 300 to be associated with the target volume in the standby node 40 upon the failover does not necessarily have to be the same as the pool number of the pool 300 in the active node 40. Moreover, in this embodiment, a “volume(s)” is a VVOL(s); however, the present invention can be applied to redeployment of volumes of types other than the VVOL(s).

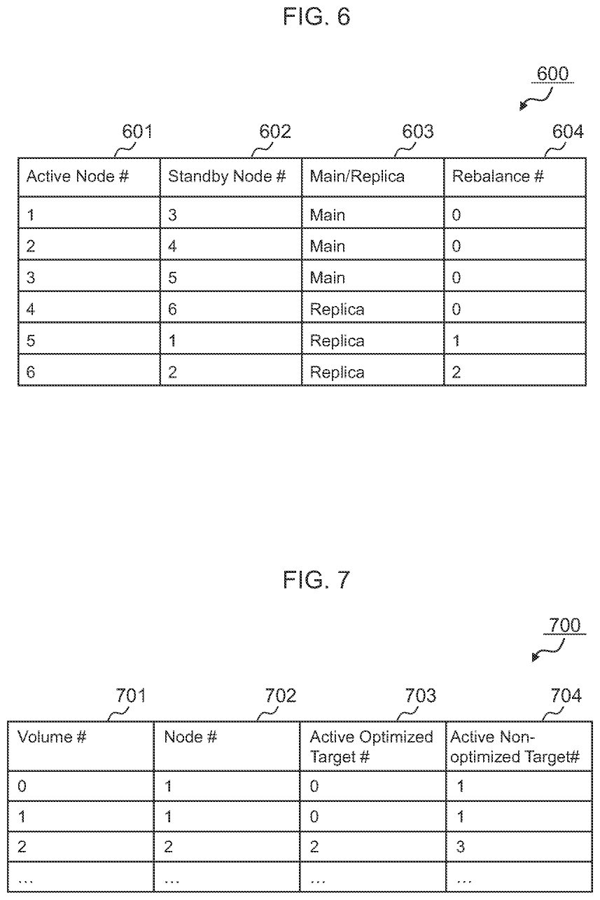

FIG. 6 illustrates a structure example of the cluster management table 600.

The cluster management table 600 has an entry for each redundant group. Each entry retains information of an active node number 601, a standby node number 602, a main/replica 603, and a rebalance number 604. One redundant group will be taken as an example (a “target redundant group” in the explanation of FIG. 6). In this embodiment, there is one standby node 40 for one redundant group; however, two or more standby nodes 40 may exist.

The active node number 601 indicates the identification number of the active node 40 in the target redundant group. The standby node number 602 indicates the identification number of the standby node 40 in the target redundant group.

The main/replica 603 indicates whether the active node 40 in the target redundant group is a main node or a replica node. The main node is a node which can issue an instruction of a resource configuration change (for example, a volume creation) in the storage cluster 30. If any one of main nodes is blocked, any one of replica nodes becomes a main node. Referring to the example illustrated in FIG. 6, for example, the following occurs.
If a failover from the active node #1 to the standby node #3 is performed, the node #3 becomes active.
As a result, if the number of the main nodes becomes less than a specified number, any one of the replica nodes (for example, the node #4) becomes a main node.

The rebalance number 604 indicates a rebalance number (the identification number of a rebalance type) of the active node 40 (a “target node 40” in this paragraph) in the target redundant group. There are three values “2,” “1,” and “0” as the rebalance number 604. They are defined as follows:
The number “2” means that the target node 40 is a migration target node, that is, a node which becomes a migration destination of the relevant volume.
The number “1” means that the target node 40 is a migration-permitted node, that is, a node which becomes a migration source of the relevant volume.
The number “0” means that the target node 40 is a default node, that is, a node which does not become either the migration destination or the migration source of the relevant volume.

FIG. 7 illustrates a structure example of the ALUA management table 700.

The ALUA management table 700 has an entry for each volume (VVOL 200). Each entry retains information of a volume number 701, a node number 702, an active optimized target number 703, and an active non-optimized target number 704. One volume will be taken as an example (a “target volume” in the explanation of FIG. 7).

The volume number 701 indicates the identification number of the target volume. The node number 702 indicates the identification number of a node 40 where the target volume is deployed (the active node 40).

The active optimized target number 703 and the active non-optimized target number 704 indicate the identification numbers of the shortest paths to the target volume. These identification numbers are provided to an access source of the target volume (the host computer 10 in this embodiment) and are used for the access to the target volume by the access source. According to the example illustrated in FIG. 7, a main path (a path indicated by the active optimized target number 703) and an alternate path (a path indicated by the active non-optimized target number 704) are prepared as the shortest paths and either one of the shortest paths may be selected by the access source on the basis of load on the paths or other information. Since the shortest path is a resource associated with the volume, the shortest path is redeployed concomitantly with the redeployment of the volume.

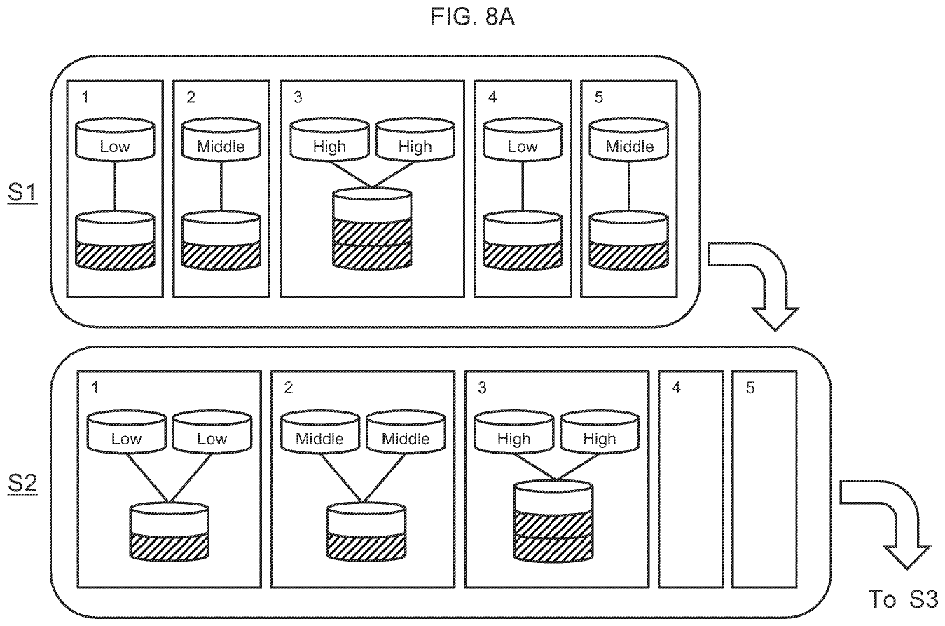

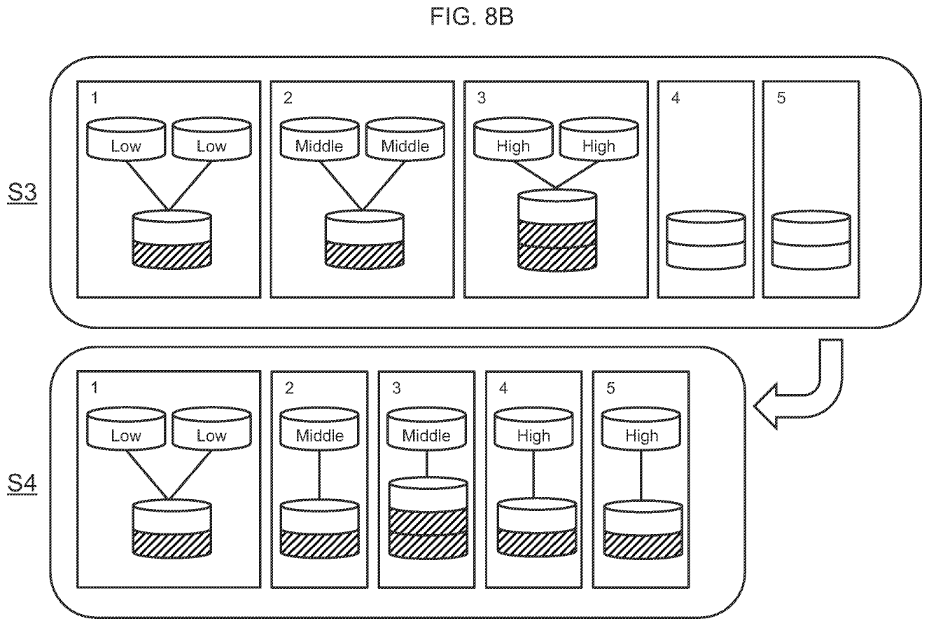

FIG. 8A and FIG. 8B illustrate the outlines of an example of new node addition processing. Incidentally, in the following explanation, definitions of terms are as follows.
A “new node” is a post-replacement node 40 or an addition target node 40. Therefore, a “new node addition” means a replacement or addition of the node 40.
A “processing node” means a node which redeploys a volume (or the aforementioned management system). For example, the processing node may be a main node which is a node defined as the main node in the storage cluster 30. When the main node is blocked due to a failure or the like, any one of the replica nodes may newly become the main node.

In S1, the storage cluster 30 is configured of nodes #1 to #5 (hereinafter referred to as existing nodes #1 to #5) and is in a state where the QoS function (the QoS provision program 850) of each node 40 is enabled. A volume with the priority “Low” is deployed in the node #4 and a volume with the priority “Middle” is deployed in the node #5.

In S2, it is assumed that the existing nodes #4 and #5 are replaced with new nodes #4 and #5. In this case, the processing node causes each of volumes which are deployed in the existing nodes #4 and #5 to be saved in any one of the existing nodes #1 to #3. According to the example illustrated in FIG. 8A, the volume with the priority “Low” deployed in the node #4 is saved to the node #1 and the volume with the priority “Middle” deployed in the node #5 is saved to the node #2. The processing node may select, as a save destination, any one of active storage nodes in a plurality of main redundant groups according to the priority (the QoS status) of the save target volume and the priority of the volume in each existing node on the basis of at least one of the volume management table 500 and the cluster management table 600.

Subsequently, as illustrated in S3, the new nodes #4 and #5 are added instead of the existing nodes #4 and #5 and the processing node judges whether or not the new node #4 or #5 is applicable as a redeployment destination of the volume with the priority “High” in the existing node #3. For example, the processing node compares new node spec information (for example, information including the information 402 to 408 explained with reference to FIG. 4 about the new node #4 or #5) with existing node spec information (the information recorded in the node management table 400 about the existing node #3). According to the information 402 to 408, there are CPU performance, drive performance, DIMM performance, and NIC performance as performance items Specifically speaking, the number N of the performance items (spec items) which influence the node spec is N=4 in this embodiment. The number N of the performance items may be more than or less than 4. If the processing node determines that the spec of the new node #4 or #5 is superior to the spec of the existing node #3 (for example, if the number of the performance items regarding which the new node is determined to be superior exceeds α (α≤N)), the processing node sets the new node #4 or #5 as the deployment destination of the volume with the priority “High” in the existing node #3. According to the example illustrated in FIG. 8B, as illustrated in S4, the redeployment destination of one volume with the priority “High” in the existing node #3 is set as the new node #4 and the redeployment destination of another volume with the priority “High” in the existing node #3 is set as the new node #5.

Incidentally, as a result of the above, some resources for the existing node #3 (for example, CPU resources and drive resources) become free and available, so that the processing node may decide a redeployment destination of a volume with the second highest priority “Middle.” For example, if the processing node determines that the spec of the existing node #3 is superior to the spec of the existing node #2, the volume with the priority “Middle” may be redeployed from the existing node #2 to the existing node #3.

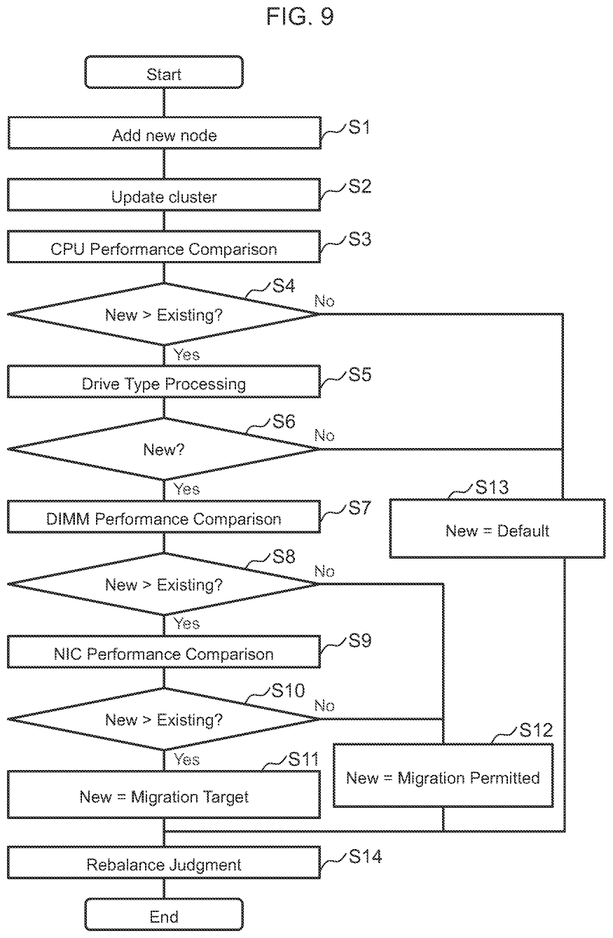

FIG. 9 illustrates a flow of processing executed when adding a new node. Incidentally, the following will be adopted as an example as appropriate in the explanation with reference to FIG. 9.
The storage cluster 30 is configured of the existing nodes #1 to #3. Of the existing nodes #1 to #3, the existing node #3 has the highest spec and the existing node #2 has the second highest spec. Therefore, the rebalance number 604 of the existing node #3 is “2” (i.e., the existing node #3 is the migration target node), the rebalance number 604 of the existing node #2 is “1” (i.e., the existing node #2 is the migration-permitted node), and the rebalance number 604 of the existing node #1 “0” (i.e., the existing node #1 is the default node).
Now, the new node #4 is added. Incidentally, at this point in time, the information of the new node #4 is not recorded in the cluster management table 600; and the information of the new node #4 is recorded in the cluster management table 600 during the processing illustrated in FIG. 9.

When adding the new node #4, the node management program 810 of the processing node acquires the information of the new node #4 through, for example, the performance acquisition program 840 of the processing node and the new node #4 and adds an entry including the acquired information in the node management table 400 (S1).

Next, the cluster management program 800 of the processing node updates the information of the cluster management table 600 along with the addition of the information of the new node #4 to the node management table 400 (S2).

Then, the cluster management program 800 of the processing node compares the CPU performance of the new node #4 with the CPU performance of the existing nodes #1 to #3 (S3) and judges whether or not the CPU performance of the new node #4 is higher than the CPU performance of the existing nodes #1 to #3 (S4).

If the judgment result of S4 is true (S4: Yes), the cluster management program 800 of the processing node identifies the drive type of the new node #4 (S5). The cluster management program 800 of the processing node judges, on the basis of the drive type of the new node #4, whether or not the drive performance of the new node #4 is higher than the drive performance of the existing nodes #1 to #3 (S6).

If the judgment result of S6 is true (S6: Yes), the cluster management program 800 of the processing node compares the DIMM performance of the new node #4 with the DIMM performance of the existing nodes #1 to #3 (S7) and judges whether or not the DIMM performance of the new node #4 is higher than the DIMM performance of the existing nodes #1 to #3 (S8).

If the judgment result of S8 is true (S8: Yes), the cluster management program 800 of the processing node compares the NIC performance of the new node #4 with the NIC performance of the existing nodes #1 to #3 (S9) and judges whether or not the NIC performance of the new node #4 is higher than the NIC performance of the existing nodes #1 to #3 (S10).

If the judgment result of S10 is true (S10: Yes), the cluster management program 800 of the processing node adds the information indicating the new node #4 as the migration target node to the cluster management table 600 (S11). Specifically speaking, according to the information which is added here, the rebalance number 604 corresponding to the new node #4 is “2.” Then, the rebalance number 604 of the existing node #3 which has the spec inferior to that of the new node #4 is ranked down from “2” to “1” and the rebalance number 604 of the existing node #2 whose spec is more inferior is ranked down from “1” to “0.” Furthermore, the new node #4 is registered as a replica node.

If the judgment result of S10 or S8 is false (S10: No or S8: No), the cluster management program 800 of the processing node adds the information indicating the new node #4 as the migration-permitted node to the cluster management table 600 (S12). Specifically speaking, regarding the information which is added here, the rebalance number 604 corresponding to the new node #4 is “1.”

If the judgment result of S4 or S6 is false (S4: No, or, 6: No), the cluster management program 800 of the processing node adds the information indicating the new node as the default node to the cluster management table 600 (S13). Specifically speaking, regarding the information which is added here, the rebalance number 604 corresponding to the new node #4 is “0.”

After S11, S12, or S13, the cluster management program 800 of the processing node judges whether the rebalance can be performed or not (S14).

According to an example illustrated in FIG. 9, under the condition that affirmative judgment results are obtained with respect to all the four judgment items, that is, the CPU performance, the drive performance, the DIMM performance, and the NIC performance, the new node #4 is set as the migration target node. Under the condition that a negative judgment result is obtained with respect to at least one of some judgment items (the DIMM performance and the NIC performance) among the four judgment items, the new node #4 is set as the migration-permitted node. Under the condition that a negative judgment result is obtained with respect to at least one of the remaining judgment items (the CPU performance and the drive performance) among the four judgment items, the new node #4 is set as the default node. Subsequently, whether or not the rebalance can be performed with respect to the new node #4 is judged. Since the CPU performance is considered to be the highest judgment item and the drive performance is the second highest judgment item as the judgment items which are most influential to read/write performance of the node(s), the greatest importance is given to the CPU performance and the second greatest importance is given to the drive performance in this embodiment. Which one of the attributes, that is, the migration target node, the migration-permitted node, and the default node, the new node belongs to is decided based on the above-described point of view, so that the new node can be associated with an optimum attribute and, therefore, optimum volume redeployment can be expected.

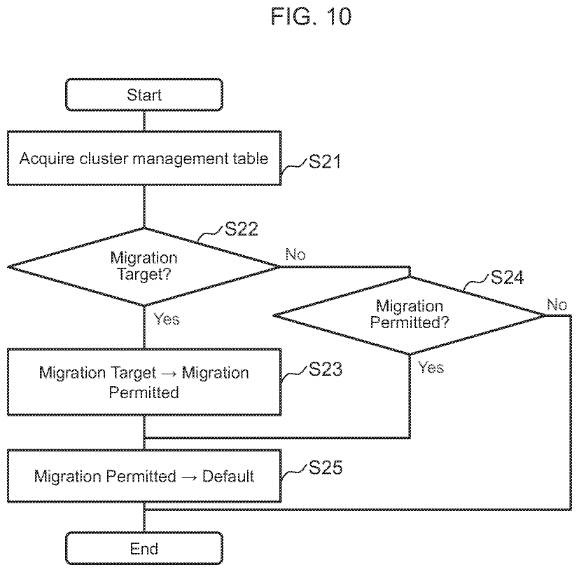

FIG. 10 illustrates a flow of the cluster management table update processing (S2 in FIG. 9).

The cluster management program 800 of the processing node acquires the cluster management table 600 (S21), refers to the acquired cluster management table 600, and judges whether the migration target node exists or not (whether the rebalance number 604 “2” exists or not) (S22).

If the judgment result of S22 is true (S22: Yes), the cluster management program 800 of the processing node changes the rebalance number 604 “2” of the existing node #3 to “1” (S23). Furthermore, the cluster management program 800 of the processing node changes the rebalance number 604 “1” of the existing node #2 to “0” (S25).

If a negative judgment result is obtained in S22 (S22: No), the cluster management program 800 of the processing node judges whether the migration-permitted node exists or not (whether the rebalance number 604 “1” exists or not) (S24). If a negative judgment result is obtained in S22 (S22: No), this processing terminates.

If the judgment result of S24 is true (S24: Yes), the cluster management program 800 of the processing node changes the rebalance number 604 “1” to “0” (S25).

The existing node #3 as the migration target node is ranked down from the migration target node to the migration-permitted node by this processing. Similarly, the existing node #2 as the migration-permitted node is ranked down from the migration-permitted node to the default node. Consequently, according to an example illustrated in FIG. 10, if a new node is added and if a node which corresponds to the migration target node or the migration-permitted node exists regardless of whether or not the spec of the new node is higher than the spec of the existing node in S2 in FIG. 9 (processing in FIG. 10), that node is ranked down by one level. Subsequently, a judgment is made with respect to at least one of the four judgment items, that is, the CPU performance, the drive performance, the DIMM performance, and the NIC performance (at least the CPU performance in the example illustrated in FIG. 9). By executing processing for updating necessary information (the rebalance number 604) after adding an entry including the information of the new node to the node management table 400 and then performing the judgment of the CPU performance, etc., easy traceability in terms of the program can be expected.

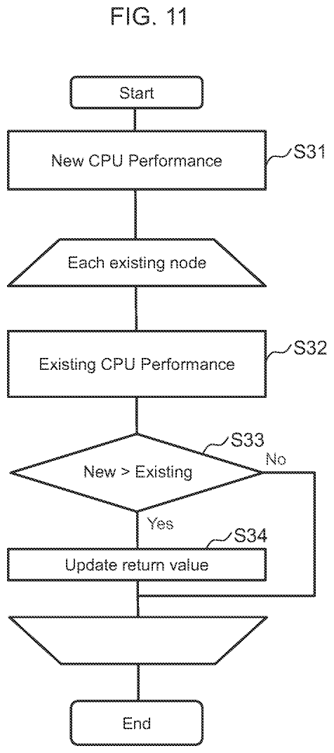

FIG. 11 illustrates a flow of the CPU performance comparison processing (S3 in FIG. 9).

The cluster management program 800 of the processing node identifies information indicating the CPU performance of the new node #4 (hereinafter referred to as “new CPU performance information”) through, for example, the performance acquisition program 840 of the new node #4 and the processing node (S31).

Subsequently, the cluster management program 800 executes S32 to S34 with respect to each existing node. One existing node will be taken as an example. Incidentally, if the rebalance number 604 “1” exists (that is, if the migration-permitted node exists) in the cluster management table 600, the existing node to be compared (the existing node on which S32 to S34 are executed) may be only the migration-permitted node. This is because the migration-permitted node is a node having the highest spec in the storage cluster 30, except for the new node.

The cluster management program 800 of the processing node acquires the information indicating the CPU performance of the existing node (hereinafter referred to as “existing CPU performance information”) from the node management table 400 (S32), compares the new CPU performance information acquired in S31 with the existing CPU performance information acquired in S32, and judges whether the new CPU performance is higher than the existing CPU performance or not (S33). For example, the new CPU performance information and the existing CPU performance information include the CPU generation 402, the number of cores 403, and the clock frequency 404. A judgment standard to determine that the CPU has higher performance may be that the CPU is more excellent with respect to any one of the CPU generation 402, the number of cores 403, and the clock frequency 404. The priorities of the information 402 to 404 may be, for example, the CPU generation 402, the number of cores 403, and the clock frequency 404 in descending order as listed. Therefore, for example, if the CPU generation 402 is more excellent, it may be determined that the CPU performance is more excellent even if the number of cores 403 is smaller.

If the judgment result of S33 is true (S33: Yes), that is, if the new CPU performance is higher than the existing CPU performance, the cluster management program 800 of the processing node updates a return value regarding the relevant existing node (the return value of this processing) (S34). As a result of S34, the return value is updated to a value indicating that the new CPU performance is high. In other words, an initial value of the return value is a value indicating that the existing CPU performance is excellent.

After this processing, the return value is obtained for each existing node. If the return values of all the existing nodes are values indicating that the new CPU performance is high, the judgment result of S4 in FIG. 9 is true.

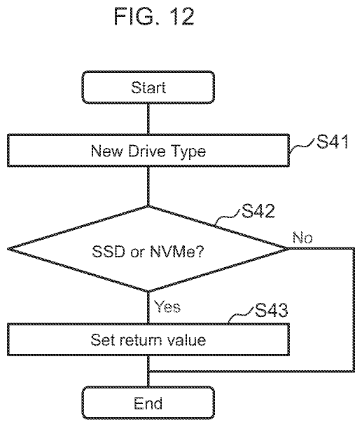

FIG. 12 illustrates a flow of the drive type judgment processing (S5 in FIG. 9).

The cluster management program 800 of the processing node identifies information indicating the drive type of the new node #4 (hereinafter referred to as “new drive type information”) through, for example, the performance acquisition program 840 of the new node #4 and the processing node (S41).

The cluster management program 800 of the processing node judges whether or not the new drive type indicated by the new drive type information acquired in S41 is “SSD” or “NVMe” (S42).

If the judgment result of S43 is true (S43: Yes), the cluster management program 800 of the processing node updates the return value (the return value of this processing) (S44). As a result of S44, the return value is updated to a value indicating that the new drive performance is high.

After this processing, the return value is obtained. If the return value is a value indicating that the new drive performance is high, the judgment result of S6 in FIG. 9 is true.

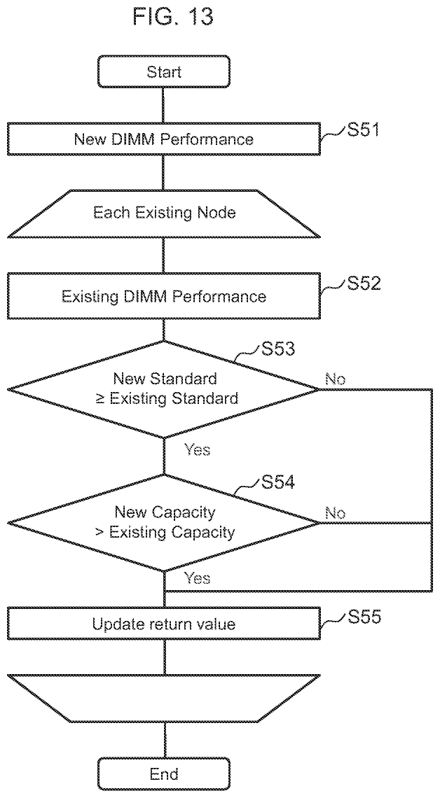

FIG. 13 illustrates a flow of the DIMM performance comparison processing (S7 in FIG. 9).

The cluster management program 800 of the processing node identifies information indicating the DIMM performance of the new node #4 (hereinafter referred to as “new DIMM performance information”) through, for example, the performance acquisition program 840 of the new node #4 and the processing node (S51).

Subsequently, the cluster management program 800 executes S52 to S55 with respect to each existing node. One existing node will be taken as an example. Incidentally, if the rebalance number 604 “1” exists (that is, if the migration-permitted node exists) in the cluster management table 600, the existing node to be compared (the existing node on which S52 to S55 are executed) may be only the migration-permitted node. This is because the migration-permitted node is a node having the highest spec in the storage cluster 30, except for the new node.

The cluster management program 800 of the processing node acquires information indicating the DIMM performance of the existing node (hereinafter referred to as “existing DIMM performance information”) from the node management table 400 (S52). The new DIMM performance information and the existing DIMM performance information include the DIMM standards 406 and the DIMM capacity 40. The standards and capacity indicated by the information 406 and 407 among the new DIMM performance information will be referred to as “new DIMM standards” and “new DIMM capacity”; and the standards and capacity indicated by the information 406 and 407 among the existing DIMM performance information will be referred to as “existing DIMM standards” and “existing DIMM capacity.”

The cluster management program 800 of the processing node judges whether or not the new DIMM standards are the same as or higher than the existing DIMM standards (S53). If the judgment result of S53 is true (S53: Yes), the cluster management program 800 of the processing node judges whether or not the new DIMM capacity is larger than the existing DIMM capacity (S54).

If the judgment result of S54 is true (S54: Yes), that is, if the new DIMM performance is higher than the existing DIMM performance, the cluster management program 800 of the processing node updates a return value regarding the relevant existing node (the return value of this processing) (S55). As a result of S55, the return value is updated to a value indicating that the new DIMM performance is high. In other words, an initial value of the return value is a value indicating that the existing DIMM performance is excellent.

After this processing, the return value is obtained regarding each existing node. If the return values of all the existing nodes are values indicating that the new DIMM performance is high, the judgment result of S8 in FIG. 9 is true.

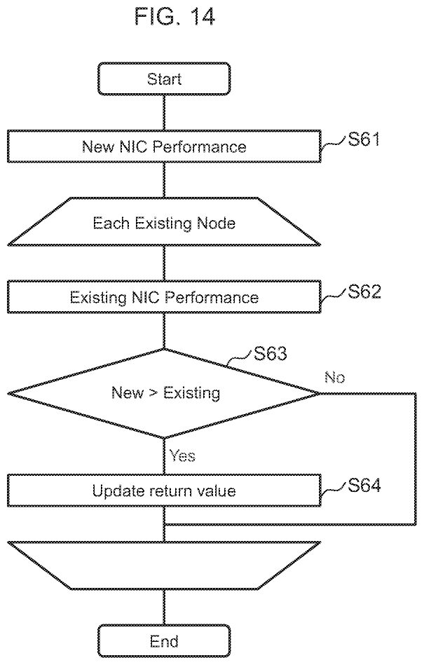

FIG. 14 illustrates a flow of the NIC performance comparison processing (S9 in FIG. 9).

The cluster management program 800 of the processing node identifies information indicating the NIC performance of the new node #4 (hereinafter referred to as “new NIC performance information”) through, for example, the performance acquisition program 840 of the new node #4 and the processing node (S61).

Subsequently, the cluster management program 800 executes S62 to S64 with respect to each existing node. One existing node will be taken as an example. Incidentally, if the rebalance number 604 “1” exists (that is, if the migration-permitted node exists) in the cluster management table 600, the existing node to be compared (the existing node on which S62 to S64 are executed) may be only the migration-permitted node. This is because the migration-permitted node is a node having the highest spec in the storage cluster 30, except for the new node.

the cluster management program 800 of the processing node acquires information indicating the NIC performance of the existing node (hereinafter referred to as “existing NIC performance information”) from the node management table 400 (S62), compares the new NIC performance information acquired in S61 with the existing NIC performance information acquired in S62, and judges whether the new NIC performance is higher than the existing NIC performance or not (S63). For example, the new NIC performance information and the existing NIC performance information include the NIC link speed 408. If the NIC link speed 408 is a faster speed, the NIC performance becomes higher.

If the judgment result of S63 is true (S63: Yes), that is, if the new NIC performance is higher than the existing NIC performance, the cluster management program 800 of the processing node updates a return value regarding the relevant existing node (the return value of this processing) (S64). As a result of S64, the return value is updated to a value indicating that the new NIC performance is high. In other words, an initial value of the return value is a value indicating that the existing NIC performance is excellent.

After this processing, the return value is obtained regarding each existing node. If the return values of all the existing nodes are values indicating that the new NIC performance is high, the judgment result of S10 in FIG. 9 is true.

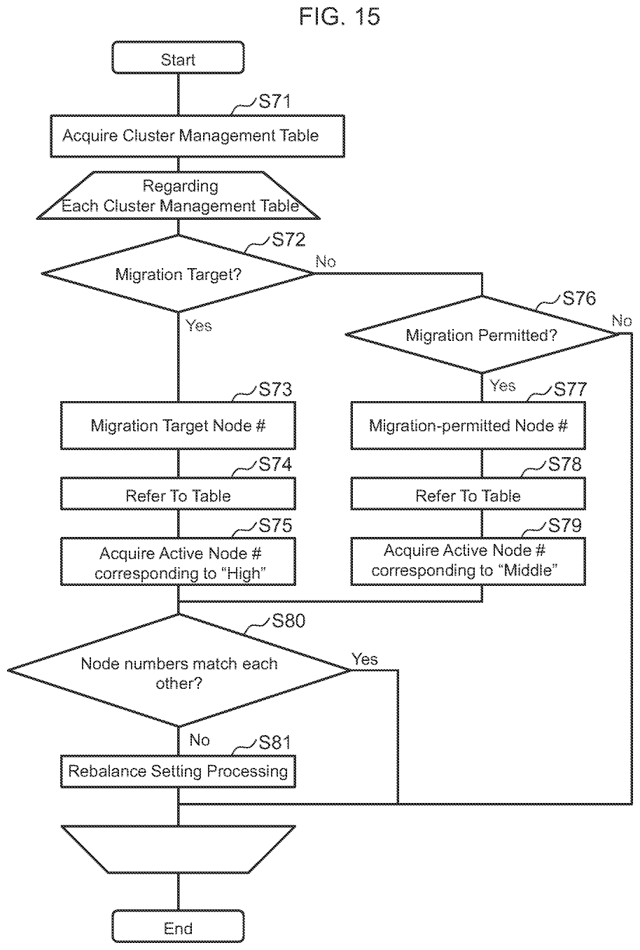

FIG. 15 illustrates a flow of the rebalance implementation possibility judgment processing (S14 in FIG. 9).

This processing is processing executed after any one of S11 to S13 in FIG. 9. Accordingly, the cluster management table 600 includes the information of the new node #4 (information including the rebalance number 604 of the new node #4).

The cluster management program 800 of the processing node acquires the relevant cluster management table 600 (S71). Subsequently, processing from S72 to S81 is executed for each acquired cluster management table. Since one storage cluster exists in this embodiment, there is one cluster management table; however, one storage system may include one or more storage clusters.

The cluster management program 800 of the processing node refers to the cluster management table 600 acquired in S71 and judges if the migration target node (the rebalance number 604 “2”) exists or not (S72).

If the judgment result of S72 is true (S72: Yes), the cluster management program 800 of the processing node acquires the active node number 601 corresponding to the rebalance number 604 “2” (S73). Furthermore, the cluster management program 800 of the processing node refers to the volume management table 500 (S74) and acquires the active node number 503 corresponding to the QoS status 502 “High” (S75). The cluster management program 800 of the processing node judges whether or not the active node number 601 identified in S73 (i.e., the node number of the migration target node) matches the active node number 503 acquired in S75 (i.e., the node number of the node 40 where the volume with the priority “High” is deployed) (S80). If the judgment result of S80 is false (S80: No), the cluster management program 800 of the processing node sets the node number of the node 40 where the volume with the priority “High” is deployed, as a migration source node, sets the volume number of the volume with the priority “High” as a migration target volume, sets the number of the shortest path associated with the relevant volume (the active optimized target number which can be identified from the ALUA management table 700) as a migration target path, and sets the node number of the migration target node as a migration destination node (S81). Consequently, the rebalance processing program 830 of the processing node (or the migration source node and the migration destination node) redeploys the migration target volume (and the shortest path associated with the relevant volume) from the migration source node to the migration destination node. As a result, the volume with the priority “High” (and the shortest path associated with the relevant volume) is redeployed to the new node #4 as the migration target node.

If the judgment result of S72 is false (S72: No), the cluster management program 800 of the processing node refers to the cluster management table 600 acquired in S71 and judges whether the migration-permitted node (the rebalance number 604 “1”) exists or not (S76).

If the judgment result of S76 is true (S76: Yes), the cluster management program 800 of the processing node acquires the active node number 601 corresponding to the rebalance number 604 “1” (S77). Furthermore, the cluster management program 800 of the processing node refers to the volume management table 500 (S78) and acquires the active node number 503 corresponding to the QoS status 502 “Middle” (S79). The cluster management program 800 of the processing node judges whether or not the active node number 601 identified in S77 (i.e., the node number of the migration-permitted node) matches the active node number 503 acquired in S79 (i.e., the node number of the node 40 where the volume with the priority “Middle” is deployed) (S80). If the judgment result of S80 is false (S80: No), the cluster management program 800 of the processing node sets the node number of the node 40 where the volume with the priority “Middle” is deployed, as the migration source node, sets the volume number of the volume with the priority “Middle” as the migration target volume, sets the number of the shortest path associated with the relevant volume (the active optimized target number which can be identified from the ALUA management table 700) as the migration target path, and sets the node number of the migration-permitted node as the migration destination node (S81). Consequently, the rebalance processing program 830 of the processing node (or the migration source node and the migration destination node) redeploys the migration target volume (and the shortest path associated with the relevant volume) from the migration source node to the migration destination node. As a result, the volume with the priority “Middle” (and the shortest path associated with the relevant volume) is redeployed to the existing node #3 as the migration-permitted node.

According to this embodiment, if the new node has the highest spec, the volume with the priority “High” is deployed from the existing node to the new node and, therefore, it can be expected to maintain the service quality of the storage service for which the volume with the priority “High” is used.

Furthermore, according to this embodiment, if the migration-permitted node which was the existing node having the highest spec immediately before the addition of the new node exists, the volume with the priority “Middle” is deployed to the migration-permitted node.

Since the above-described volume redeployment can be realized, it can be expected to maintain the service quality of the storage service even in the environment for which a revenue sharing type agreement is adopted. For example, even if neither the storage vendor nor the service provider knows the intended use of the volume(s) by the end user, the priority in compliance with the service quality desired by the end user can be associated with the volume(s) used by the end user if they know the service quality desired by the end user. As a result, the volume will be redeployed to an optimum node to maintain such service quality and, therefore, it can be expected to maintain the service quality of the storage service from the service provider.

Incidentally, the present invention is not limited to the embodiments described above and includes various variations and equivalent configurations within the gist of the claims attached hereto. For example, the embodiments described above provide a detailed explanation of the present invention in order to make it easier to understand, and the present invention is not necessarily limited to embodiments including all of the explained configurations.

Furthermore, the aforementioned explanation can be summarized, for example, as described below. Incidentally, the following summary may include variations of the aforementioned explanation.

When a new node is added to the storage cluster, the processing node (or the aforementioned management system) acquires new spec information which is information indicating the spec of the new node, and existing spec information which is information indicating the spec of at least one existing node other than the new node, and compares the new spec (the spec indicated by the new spec information) with the existing spec (the spec indicated by the existing spec information). If the new spec is higher than the existing spec and if a first volume (one example is a volume with the priority “High”) exists in any one of the existing nodes, the processing node (or the management system) decides the new node as a migration destination of that first volume. Consequently, the deployment destination of the first volume can be maintained as the node with the highest spec, so that the service quality of the storage service provided by the storage cluster which can be a hetero configuration can be maintained.

If the existing node managed as the migration target node (the migration destination node of the first volume) exists when the new node is added, the processing node (or the management system) may manage that existing node as the migration-permitted node (the migration source node of the first volume). If the new spec is higher than the existing spec, the processing node (or the management system) may manage the new node as the migration target node and migrate the first volume from the existing node managed as the migration-permitted node to the new node. Accordingly, if the new spec is higher than the existing spec, the volume redeployment can be performed so that the first volume is migrated from the existing node, which is expected to have the first volume deployed because it had the highest spec before the addition of the new node, to the new node. Furthermore, as the node which was the migration target node changes to the migration-permitted node when the new node is added, the migration target node does not exist unless the new node becomes the migration target node. Therefore, it is possible to avoid the redeployment of the first volume from being carried out without newly adding a node having a higher spec than the node in which the first volume is deployed.

If a second volume (one example is a volume with the priority “Middle”) which is a volume associated with the priority lower than the first priority and equal to or higher than the second priority exists in any one of the existing nodes other than the existing node managed as the migration-permitted node, the processing node (or the management system) may decide the existing node which is managed as the migration-permitted node, as a migration destination of the above-described second volume. Consequently, the volume deployment can be performed so that the second volume is migrated to the migration-permitted node where some resources become free and available as a result of the deployment of the first volume to the migration target node.

We claim:

1. A storage system comprising a plurality of storage nodes including two or more storage nodes constituting a storage cluster for providing a virtual storage system,
wherein one or a plurality of volumes are deployed in the two or more storage nodes;
wherein a priority according to a service quality of a storage service using the volume is associated with each of the one or the plurality of volumes;
wherein as the service quality of the storage service is higher, the priority associated with the volume used for the storage service tends to be high;
wherein when a new node which is a post-replacement or addition target storage node is added by replacing any one of the storage nodes in the storage cluster or adding a storage node to the storage cluster, a processing node which is any one of the plurality of storage nodes:
acquires new spec information which is information indicating a spec of the new node, and existing spec information which is information indicating a spec of at least one existing node other than the new node in the storage cluster;
compares a new spec, which is a spec indicated by the new spec information, with an existing spec which is a spec indicated by the existing spec information; and
decides a migration destination of a first volume as the new node when the new spec is higher than the existing spec and the first volume exists in any one of existing nodes; and
wherein the first volume is a volume associated with the priority equal to or higher than a first priority.

2. The storage system according to claim 1,
wherein the processing node
when the new node is added and when there is an existing node managed as a migration target node which is a migration destination node of the first volume, manages the existing node as a migration-permitted node which is a migration source node of the first volume; and
when the new spec is higher than the existing spec, manages the new node as the migration target node and decides to migrate the first volume from the existing node managed as the migration-permitted node to the new node.

3. The storage system according to claim 2,
wherein when a second volume which is a volume associated with the priority lower than the first priority and equal to or higher than a second priority exists in any one existing node other than the existing node managed as the migration-permitted node, the processing node decides a migration destination of the second volume as the existing node managed as the migration-permitted node.

4. The storage system according to claim 3,
wherein how high the spec of the storage node is depends on N pieces of judgment items (N is an integer of 2 or more); and
wherein the processing node:
determines the new node as the migration target node when the new spec is higher with respect to the N pieces of the judgment items; and
determines the new node as the migration-permitted node when the new spec is lower with respect to at least one of some specified judgment items among the N pieces of the judgment items.

5. A volume deployment control method comprising:
when a new node which is a post-replacement or addition target storage node is added by replacing any one of storage nodes in a storage cluster which provides a virtual storage system and is configured of two or more storage nodes, or by adding a storage node to the storage cluster, performing the following (a) to (c) by a processing node which is any one of the plurality of storage nodes, or a management system which is a system coupled to at least one of the nodes:
(a) to acquire new spec information which is information indicating a spec of the new node, and existing spec information which is information indicating a spec of at least one existing node other than the new node in the storage cluster,
wherein one or a plurality of volumes are provided in the two or more storage nodes;
wherein a priority according to a service quality of a storage service using the volume is associated with each of the one or the plurality of volumes; and
wherein as the service quality of the storage service is higher, the priority associated with the volume used for the storage service tends to be high;
(b) to compare a new spec, which is a spec indicated by the new spec information, with an existing spec which is a spec indicated by the existing spec information; and
(c) to decide a migration destination of a first volume as the new node when the new spec is higher than the existing spec and the first volume exists in any one of existing nodes,
wherein the first volume is a volume associated with the priority equal to or higher than a first priority.

6. The volume deployment control method according to claim 5, wherein
when the new node is added and when there is an existing node managed as a migration target node which is a migration destination node of the first volume,
managing, by the processing node or the management system, the existing node as a migration-permitted node which is a migration source node of the first volume, and when the new spec is higher than the existing spec,
managing, by the processing node or the management system, the new node as the migration target node,
and deciding, by the processing node or the management system, to migrate the first volume from the existing node managed as the migration-permitted node to the new node.

7. The volume deployment control method according to claim 6, wherein
when a second volume which is a volume associated with the priority lower than the first priority and equal to or higher than a second priority exists in any one existing node other than the existing node managed as the migration-permitted node,
deciding, by the processing node or the management system, a migration destination of the second volume as the existing node managed as the migration-permitted node.

8. The volume deployment control method according to claim 7, wherein
how high the spec of the storage node is depends on N pieces of judgment items (N is an integer of 2 or more);
determining, by the processing node or the management system, the new node as the migration target node when the new spec is higher with respect to the N pieces of the judgment items; and
determining, by the processing node or the management system, the new node as the migration-permitted node when the new spec is lower with respect to at least one of some specified judgment items among the N pieces of the judgment items.
